(19) United States
(12) Patent Application Publication
(10) Pub. No.: US 2022/0206676 A1
(43) Pub. Date: Jun. 30, 2022

(54) MODIFYING DRAWING CHARACTERISTICS OF DIGITAL RASTER IMAGES UTILIZING STROKE PROPERTIES

(71) Applicant: Adobe Inc., San Jose, CA (US)

(72) Inventors: Yogesh Chandra Tewari, Noida (IN); Pramendra Rathi, Muzaffarnagar (IN); Deep Sinha, Ghaziabad (IN)

(21) Appl. No.: 17/135,181

(22) Filed: Dec. 28, 2020

(51) Int. Cl. G06F 3/0484; G06T 11/20; G06T 11/60

(52) U.S. Cl. CPC G06F 3/04845; G06F 3/0482; G06T 11/60; G06T 11/20

(57) ABSTRACT

Methods, systems, and non-transitory computer readable storage media are disclosed for modifying drawing characteristics of digital raster images utilizing stroke properties. Specifically, the disclosed system receives a stroke input to draw a stroke within a raster layer of a digital raster image. The disclosed system determines drawing data by capturing stroke points and properties of the stroke and then store the drawing data within a metadata file associated with the digital raster image. The disclosed system receives a request to change at least one drawing attribute of the stroke to a different drawing attribute. In response to the request, the disclosed system modifies the digital raster image by updating the drawing data for the stroke according to the request and then re-generate the raster layer including the stroke utilizing the updated drawing data.

### BACKGROUND

Improvements to computer processing technologies have led to significant advancements in digital image editing and image processing. Specifically, improvements to digital image editing tools have provided the ability to perform many different types of transformations to a digital image. For example, many systems provide digital editing tools to generate and modify digital raster images by modifying pixel values in grids of pixels representing the digital raster images. To illustrate, many systems provide digital brush tools that allow content creators to insert a variety of different stroke styles and designs into digital raster images. Because digital raster images produce a displayed image based on pixel values in a grid of pixels, modifying individual elements of a digital raster image is often a difficult and time-consuming task that often involves manual editing of the pixel values.

### SUMMARY

This disclosure describes one or more embodiments of methods, non-transitory computer readable media, and systems that solve the foregoing problems in addition to providing other benefits. In particular, the disclosed systems capture drawing data for strokes in a digital raster image by capturing stroke points and properties of the stroke. For example, the disclosed systems capture properties like time, position, pressure, velocity, angle, layer identification, and simulation duration (in the case of live brushes). The disclosed systems then store the drawing data within a metadata file associated with the digital raster image. Additionally, the disclosed systems receive a request to change at least one drawing attribute of the stroke to a different drawing attribute. In response to the request, the disclosed systems modify the digital raster image by updating the drawing data for the stroke according to the request and then re-generate the raster layer including the stroke utilizing the updated drawing data to reproduce the stroke with the different drawing attribute. Thus, the disclosed systems allow for changing a drawing attribute of a specific stroke in a digital raster image, an attribute of all strokes within a digital raster image, or an attribute of strokes that share a specific attribute within a digital raster image. Accordingly, the disclosed systems provide selective, efficient modification of individual strokes within a digital raster image.

### BRIEF DESCRIPTION OF THE DRAWINGS

The detailed description refers to the drawings briefly described below.

FIG. 1 illustrates a block diagram of a system environment in which a raster stroke modification system operates in accordance with one or more implementations.

FIG. 2 illustrates a flowchart of a series of acts for modifying strokes in a digital raster image in accordance with one or more implementations.

FIG. 3 illustrates a diagram of the raster stroke modification system generating a metadata file including drawing data for strokes in a digital raster image in accordance with one or more implementations.

FIGS. 4A-4F illustrate graphical user interfaces displaying modifications to a digital raster image in accordance with one or more implementations.

FIG. 5 illustrates an example architecture of the raster stroke modification system of FIG. 1 in accordance with one or more implementations.

FIG. 6 illustrates a flowchart of a series of acts for modifying drawing characteristics of digital raster images utilizing stroke properties in accordance with one or more implementations.

FIG. 7 illustrates a block diagram of an exemplary computing device in accordance with one or more embodiments.

### DETAILED DESCRIPTION

One or more embodiments of the present disclosure include a raster stroke modification system (or “stroke modification system”) that captures and utilizes stroke properties of strokes to modify digital raster images. Specifically, the stroke modification system determines drawing data for one or more strokes within a digital raster image. The stroke modification system stores the drawing data in a metadata file associated with the digital raster image for use in modifying the one or more strokes. To illustrate, the stroke modification system receives a request to change a first drawing attribute of a stroke to a second drawing attribute. In response to the request, the stroke modification system modifies the digital raster image by updating the drawing data according to the request to change the first drawing attribute to the second drawing attribute. Furthermore, the stroke modification system re-generates a raster layer including the stroke utilizing the updated drawing data. By determining and modifying drawing data for individual strokes, the stroke modification system efficiently and flexibly modifies properties of individual elements of a digital raster drawing.

In one or more embodiments, the stroke modification system receives drawing input (e.g., a stroke input) to draw one or more strokes within one or more a digital raster image. For example, the stroke modification system receives provides brushstroke tools for inserting brushstrokes into a digital raster image via a digital editing application. The stroke modification system also captures each stroke by utilizing a coordinate system associated with the stroke input to determine where to draw each stroke within the digital raster image. According to various embodiments, each stroke within the digital raster image includes a set of properties/attributes that determines an appearance of the stroke within the digital raster image.

Additionally, the stroke modification system determines drawing data for stroke points of a stroke. Specifically, the stroke modification system determines visual attributes and movement attributes associated with the stroke by capturing a plurality of stroke points during a drawing input. The stroke modification system then determines the visual attributes and movement attributes corresponding to the stroke points based on the selected visual attributes of the stroke input (e.g., based on a brushstroke tool) and movement associated with the stroke input. In one or more embodiments, the stroke modification system stores the determined drawing data for the stroke points in a metadata file associated with the digital raster image.

In one or more embodiments, after determining the drawing data for stroke points of strokes in a digital raster image, the stroke modification system receives a request to change at least one drawing attribute of one or more strokes to a different drawing attribute. For example, the stroke modification system receives a request to modify a visual attribute of a stroke within a raster layer of the digital raster image. In various embodiments, the stroke modification system receives a request to change a drawing attribute of a specific stroke, an attribute of all strokes within a raster layer, or an attribute of strokes that share a specific attribute within a raster layer.

In one or more additional embodiments, the stroke modification system modifies a digital raster image in response to a request to change a drawing attribute of a stroke within the digital raster image. In particular, the stroke modification system first updates the drawing data for the corresponding stroke with the requested change. For example, the stroke modification system obtains the drawing data for the corresponding stroke (e.g., for the corresponding stroke points) from the metadata file and changes a drawing attribute in the obtained drawing data to the selected drawing attribute. The stroke modification system then modifies the digital raster image by re-generating the raster layer including the stroke utilizing the updated drawing data.

As mentioned, digital raster images produce a displayed image based on pixel values in a grid of pixels. Typically, a user only has the ability to undo an entire drawing stack to modify a stroke and cannot pick and replace a set of strokes or an individual stroke from the entire drawing. Alternatively, to modify digital raster images, many existing systems provide tools for manually modifying portions of the digital raster images. For example, some conventional image editing systems allow users to manually select portions of digital raster images and then perform modifications to the portions by utilizing a variety of brushstroke tools or filters. While the existing conventional systems provide tools for editing digital raster images, the conventional systems lack efficiency because they require significant manual editing of individual pixels or pixel groups with manual selection of the pixels/pixel groups. Accordingly, modifying raster pixel values utilizing conventional systems is often a difficult and time-consuming task.

Furthermore, the existing systems lack flexibility due to the inability to modify specific stroke attributes directly. Rather, the conventional image editing systems modify pixel values of specific pixels in raster layers in response to manual user selection and modification of the individual pixels or based on filter transformations to the pixel values within the digital raster image. Accordingly, conventional systems are unable to modify attributes of individual strokes directly and instead rely on manual selection or automatic detection/modification of pixel values within digital raster images.

The disclosed stroke modification system provides a number of advantages over existing systems. For example, the stroke modification system improves the efficiency of computing systems that edit digital raster images. To illustrate, while computing processes have improved significantly to provide faster image processing for automatically detecting and manipulating digital raster images, modifying manually inserted brushstrokes remains a tedious task. In particular, by determining and storing stroke properties of points from individual strokes of a digital raster image, the stroke modification system provides efficient modification of individual strokes of the digital raster image. More specifically, in contrast to conventional systems that modify pixel values of a digital raster image based on selected groups of pixels, the stroke modification system captures and maintains stroke properties as the strokes are input (e.g., created) for later use in quickly modifying the strokes within a digital raster image.

Additionally, the stroke modification system improves the flexibility of computing systems that edit digital raster images. Specifically, by storing drawing data for individual strokes within a metadata file associated with a digital raster image, the stroke modification system separately modifies strokes by updating drawing data for points of the corresponding strokes. The stroke modification system also utilizes the stored drawing data to provide modification of strokes in groups, such as by modifying strokes within a single raster layer or strokes in a raster layer that share an attribute. Thus, the stroke modification system provides flexible modification of individual strokes in a digital raster image by modifying drawing data for the corresponding stroke points and regenerating the strokes so they include the modified attributes based on the modified drawing data.

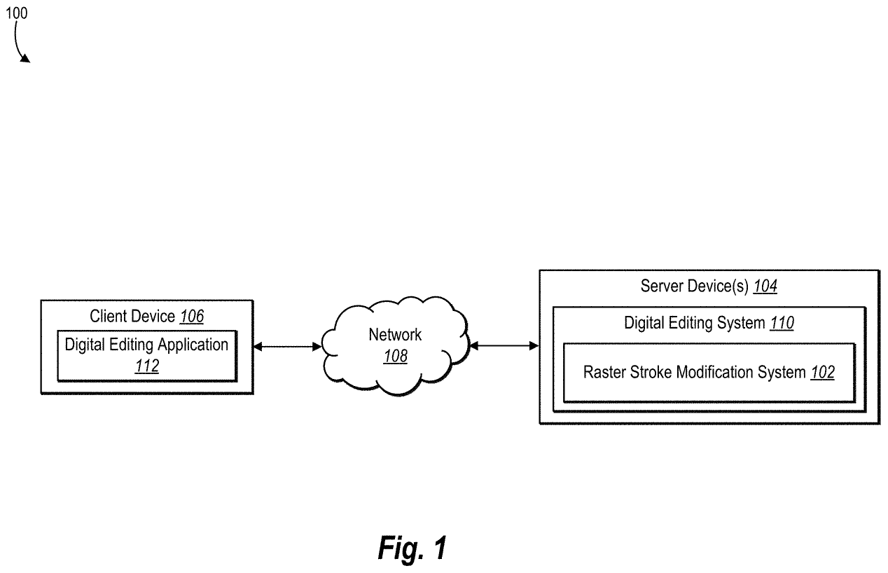

Turning now to the figures, FIG. 1 illustrates a schematic diagram of a system environment 100 in which a raster stroke modification system 102 (or “stroke modification system 102”) operates. In particular, the system environment 100 includes server device(s) 104 and a client device 106 in communication via a network 108. Moreover, as shown, the server device(s) 104 include a digital editing system 110, which includes the stroke modification system 102. Furthermore, the client device 106 includes a digital editing application 112 (e.g., a digital raster image editing application).

As shown in FIG. 1, the server device(s) 104 includes or hosts the digital editing system 110. In one or more embodiments, the digital editing system 110 includes, or is part of, one or more systems that implement the management and editing of digital images (e.g., digital raster images) for storing, creating, modifying, or displaying digital images for one or more users of the digital editing system 110. For example, the digital editing system 110 provides tools for generating, editing, or otherwise interacting with digital images using one or more graphical user interface tools via the digital editing application 112 on the client device 106. In some embodiments, the digital editing system 110 provides a graphical user interface (e.g., within a standalone client or a web browser) to the client device 106 for a user to interact with three-dimensional environments via the digital editing application 112 on the client device 106.

As mentioned, the digital editing system 110 provides tools for generating, editing, or otherwise interacting with digital images. In one or more embodiments, the digital editing system 110 provides tools for generating and rendering digital raster images. In one or more embodiments, a digital raster image includes a pixel map representation of computer data for display on a display device. For example, a digital raster image includes a grid of pixels for which each pixel includes a pixel value indicating a display color of the pixel. To illustrate, each pixel in a digital raster image includes an RGB color value indicating the display color for a particular pixel location of the digital raster image.

Accordingly, the digital editing system 110 provides tools for editing digital raster images via the digital editing application 112 on the client device 106. For instance, the digital editing system 110 provides tools for modifying pixel values in a grid of pixels by inserting one or more brushstroke tools, fill tools, erasing tools, transformation tools, and/or filter tools. The digital editing system 110 also interacts with a rendering engine associated with the client device 106 for rendering digital images on a display device of the client device 106. Additionally, the digital editing system 110 provides digital raster images for use in a variety of applications including, but not limited to, media generation, social media applications, or databases of digital images or video.

In connection with generating, editing, or interacting with digital raster images, the digital editing system 110 includes the stroke modification system 102 for modifying stroke properties of strokes within a digital raster image. In one or more embodiments, the stroke modification system 102 analyzes drawing inputs to draw strokes within a digital raster image (e.g., via the digital editing application 112 of the client device 106) to determine drawing data for each stroke inserted into the digital raster image. In one or more embodiments, a stroke includes a drawn line that extends from a first point to a second point (e.g., via an input device of the client device 106 beginning at the first point and stopping at the second point). For instance, a stroke has a shape (e.g., a straight line, curved line, and/or a combination of curves or straight lines) as determined by a drawing input from the input device. Additionally, in one or more embodiments, a stroke passes through one or more points between the first point and the second point.

In one or more additional embodiments, a drawing input (or a stroke input) includes an input to a computing device (e.g., the client device 106) to draw a stroke in a digital raster image. For example, a drawing input includes an input by a drawing tool to draw a raster element within a digital raster image. In one or more embodiments, a drawing input includes an input by a brushstroke tool to draw a stroke from a beginning input point to an ending input point within a digital raster image. In one or more embodiments, a drawing input includes an input by a fill tool to insert a filled region into a defined portion of a digital raster image. Additionally, in one or more embodiments, a drawing input corresponds to an input by a mouse, a digital stylus/pen, or a touchscreen to insert a stroke into a digital raster image via the digital editing application 112.

Furthermore, in one or more embodiments, the stroke modification system 102 determines drawing data for strokes inserted into a digital raster image. To illustrate, the stroke modification system 102 captures drawing points associated with a drawing input to insert a stroke into a digital raster image. The stroke modification system 102 determines drawing data for the drawing points and stores the drawing data within a metadata file associated with the digital raster image. In one or more embodiments, drawing data includes information that describes an appearance and/or movement properties of a drawing input for inserting a stroke into a digital raster image. For instance, drawing data includes drawing attributes (e.g., stroke style, stroke size, opacity) and movement attributes (e.g., direction, velocity, pressure, angle(s)). In one or more embodiments, drawing data includes coordinates of each drawing point in a stroke.

In one or more embodiments, drawing points include a plurality of points captured from an input device for drawing a raster element in a digital raster image. For example, drawing points include points corresponding to a plurality of input points in a drawing input from the input device relative to a coordinate system. To illustrate, drawing points include stroke points along a path corresponding to a stroke that a drawing input draws within a digital raster image. Alternatively, drawing points indicate a boundary of a region for filling the region with a specific filling material/brushstroke. In one or more embodiments, the stroke modification system 102 utilizes a coordinate system corresponding to an input stream and/or a display device of the client device 106 indicating locations of inputs relative to a digital raster image. Thus, the stroke modification system 102 captures drawing points by determining a set of coordinates along a path corresponding to a stroke inserted into a digital raster image.

Furthermore, the stroke modification system 102 utilizes drawing data associated with strokes to modify attributes of stroke points in response to a request to change an attribute of a stroke within a digital raster image (e.g., via the digital editing application 112 on the client device 106). In particular, the stroke modification system 102 accesses existing drawing data from a metadata file associated with the digital raster image and then updates the drawing data based on the request. Furthermore, the stroke modification system 102 provides updated drawing data to a rendering engine on the client device 106 to modify the digital raster image according to the requested change by regenerating the stoke and/or layer to include the modified attribute.

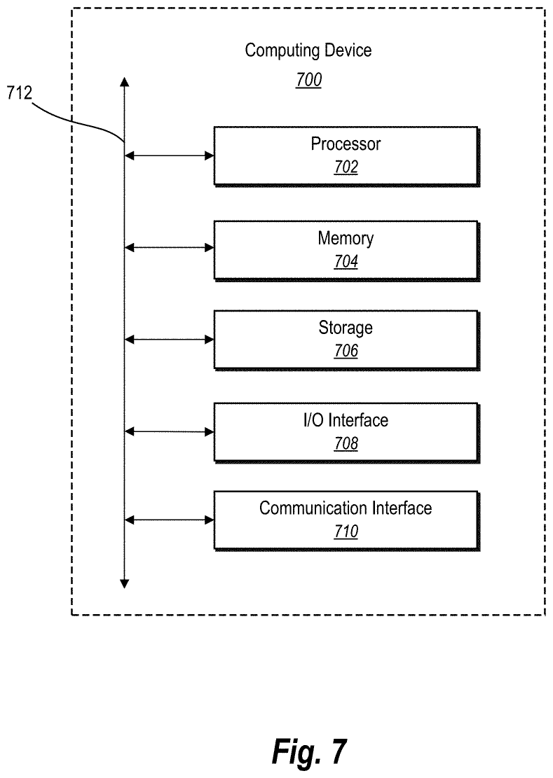

In addition, as shown in FIG. 1, the system environment 100 includes the client device 106. In one or more embodiments, the client device 106 includes, but is not limited to, a mobile device (e.g., smartphone or tablet), a laptop, or a desktop, including those explained below with reference to FIG. 7. Furthermore, although not shown in FIG. 1, in one or more embodiments, the client device 106 is operated by a user (e.g., a user included in, or associated with, the system environment 100) to perform a variety of functions. In particular, the client device 106 performs functions, such as, but not limited to, accessing, viewing, and interacting with digital images (e.g., via the digital editing application 112). Additionally, in some embodiments, the client device 106 performs functions for generating and editing digital raster images to provide to the digital editing system 110 or another system via the network 108. Although FIG. 1 illustrates the system environment 100 with a single client device 106, in some embodiments, the system environment 100 includes a different number of client devices.

In one or more embodiments, the server device(s) 104 include a variety of computing devices, including those described below with reference to FIG. 7. For example, the server device(s) 104 includes one or more servers for storing and processing data for digital content items (e.g., digital raster images) associated with a plurality of users of the digital editing system 110 or the stroke modification system 102. In some embodiments, the server device(s) 104 also include a plurality of computing devices in communication with each other, such as in a distributed storage environment. In some embodiments, the server device(s) 104 comprise a content server for storing digital images. In additional embodiments, the server device(s) 104 also comprises an application server, a communication server, a web-hosting server, a social networking server, a digital content campaign server, or a digital communication management server.

Additionally, as shown in FIG. 1, the system environment 100 includes the network 108. The network 108 enables communication between components of the system environment 100. In one or more embodiments, the network 108 may include the Internet or World Wide Web. Additionally, in some embodiments, the network 108 includes various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, in one or more embodiments, the server device(s) 104 and the client device 106 communicate via the network using a variety of communication platforms and technologies suitable for transporting data and/or communication signals, including any known communication technologies, devices, media, and protocols supportive of data communications, examples of which are described with reference to FIG. 7.

Although FIG. 1 illustrates the server device(s) 104 and the client device 106 communicating via the network 108, in one or more embodiments, the various components of the system environment 100 communicate and/or interact via other methods (e.g., the server device(s) 104 and the client device 106 communicate directly). Furthermore, although FIG. 1 illustrates the stroke modification system 102 being implemented by a particular component and/or device within the system environment 100, in one or more embodiments, the stroke modification system 102 is implemented, in whole or in part, by other computing devices and/or components in the system environment 100 (e.g., the client device 106). For example, rather than the digital editing system 110 and stroke modification system 102 being hosted on the server device(s) 104 and supporting the digital editing application 112, the digital editing system 110 and stroke modification system 102 resides and runs directly on the client device 106.

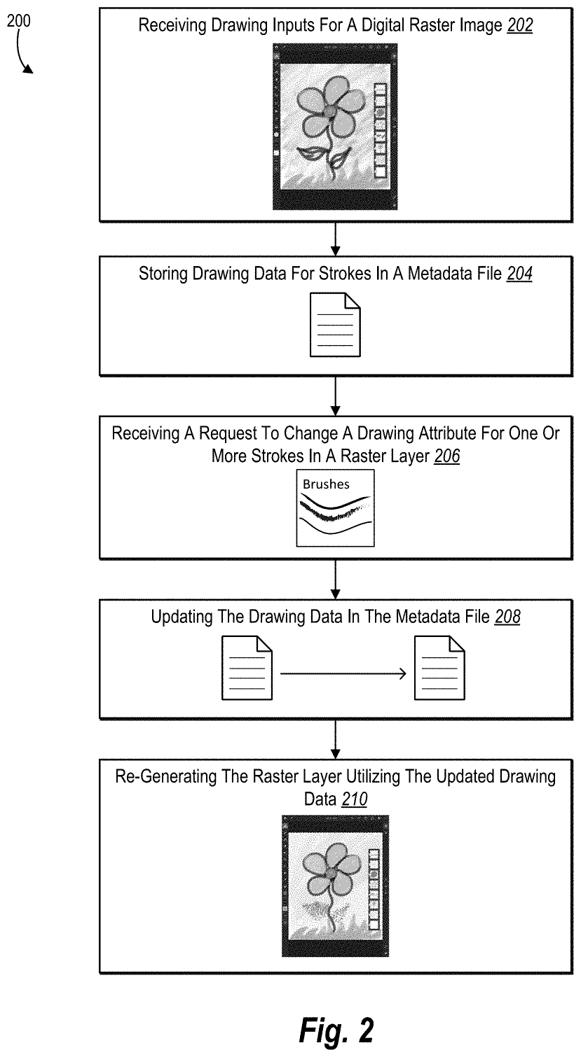

FIG. 2 illustrates an overview of a process for modifying a stroke within a digital raster layer by modifying stroke properties associated with the stroke. Specifically, FIG. 2 illustrates that the stroke modification system 102 utilizes drawing data from metadata to modify stroke properties within a raster layer. For example, the stroke modification system 102 stores drawing data for the stroke in a metadata file and then modifies the digital raster image based on a request to change stroke properties of the stroke utilizing the drawing data in the metadata file.

As illustrated in FIG. 2, the stroke modification system 102 performs a series of acts 200 to modify stroke properties within a digital raster image. In one or more embodiments, the series of acts 200 first includes an act 202 of receiving drawing inputs for a digital raster image. For example, the stroke modification system 102 receives drawing inputs from one or more raster drawing tools within a digital editing application. To illustrate, the stroke modification system 102 receives one or more stroke inputs to draw one or more strokes within one or more raster layers of a digital raster image. For example, the stroke modification system 102 receives drawing inputs to draw strokes within a new digital raster image or a previously generated digital raster image.

In one or more embodiments, a raster layer includes a level of a digital raster image including one or more raster elements. For example, a raster layer includes a set of pixels that correspond to the raster layer and are separate from pixels in other raster layers. To illustrate, a raster layer includes one or more raster elements generated utilizing one or more drawing tools (e.g., brushstroke tools, fill tools, transformation tools) to assign pixel values to the set of pixels corresponding to the raster layer. Furthermore, in one or more embodiments, a raster layer includes one or more layer properties that apply to the entire raster layer including, but not limited to, opacity, blend/mixing mode, visibility, layer linking, and layer level. The layer properties indicate an effect of the raster layer on one or more other raster layers within a digital raster image.

Additionally, in one or more embodiments, a digital raster image includes any number of raster layers, each raster layer comprising its own set of raster elements (e.g., one or more strokes and/or other elements). Accordingly, when rendering a digital raster image, the digital editing system 110 of FIG. 1 combines raster layers to generate a displayed digital raster image. For instance, the digital editing system 110 utilizes the contents and layer properties of each raster layer to determine a displayed pixel value for each pixel in a grid of pixels. In one or more embodiments, the digital editing system 110 also provides operations for exporting a digital raster image to a file type such as, but not limited to, a JPEG file, a PNG file, a TIFF file, a BMP file, or a GIF file including combined raster layers for the digital raster image.

FIG. 2 also illustrates that the series of acts 200 includes an act 204 of storing drawing data for strokes in a metadata file. In one or more embodiments, the stroke modification system 102 determines drawing data based on the drawing inputs for the digital raster image. For example, the stroke modification system 102 utilizes information about the drawing inputs to determine properties of strokes within the digital raster image. More specifically, the stroke modification system 102 captures a plurality of stroke points from a stroke input according to a coordinate system associated with an input device associated with the stroke input. In one or more embodiments, the stroke modification system 102 captures stroke points including coordinates at specific intervals (e.g., distance intervals or time intervals) along a path that a resulting stroke follows based on the stroke input.

In connection with determining coordinates for a plurality of drawing points, the stroke modification system 102 also determines additional drawing attributes for the drawing points. To illustrate, the stroke modification system 102 determines visual attributes and movement attributes associated with each drawing point. For instance, the stroke modification system 102 determines visual attributes that determine how a stroke appears within a raster layer of a digital raster image. In one or more embodiments, visual attributes for a stroke point include, but are not limited to, a stroke type, a shape, a stroke size/width, an opacity, or color properties. In one or more additional embodiments, the stroke modification system 102 determines the visual attributes for each stroke point in a stroke based on properties of a selected brushstroke corresponding to the drawing input that draws the stroke.

In one or more embodiments, the stroke modification system 102 determines movement attributes indicating movement of a drawing input for drawing a stroke. Specifically, the stroke modification system 102 determines the movement of a drawing input drawing a stroke within a digital raster image. For example, the stroke modification system 102 determines movement attributes for a stroke point including, but not limited to, a velocity, a pressure, one or more drawing angles, or a time. In one or more embodiments, the movement attributes also affect one or more visual attributes of a stroke based on the drawing input. To illustrate, certain brushstroke types or other brushstroke properties alter the appearance of a stroke in response to different movements, such as by changing a rotation, opacity, size, density, or pattern of a stroke with changes in speed, pressure, or angle.

After determining the drawing data associated with a stroke in a digital raster image, the stroke modification system 102 stores the drawing data with the drawing points. In one or more embodiments, the stroke modification system 102 stores the drawing data for a plurality of drawing points of a stroke within a metadata file associated with the digital raster image. For instance, the stroke modification system 102 generates a metadata file linked to the digital raster image (e.g., the metadata file references the digital raster image and/or vice versa) and then stores the drawing data associated with one or more strokes from the digital raster image in the metadata file.

FIG. 2 further illustrates that the series of acts 200 includes an act 206 of receiving a request to change a drawing attribute for one or more strokes in a raster layer. In one or more embodiments, the stroke modification system 102 provides drawing tools for modifying previously drawn strokes within a raster layer (e.g., via a digital editing application). The stroke modification system 102 receives a request to modify one or more strokes within a raster layer by changing at least one drawing attribute of the one or more strokes to a different drawing attribute. In one or more embodiments, the request includes a request to change a visual attribute of a specific stroke in a raster layer to a different visual attribute. In one or more additional embodiments, the request includes a request to change a visual attribute of a plurality of strokes in a raster layer to a different visual attribute. In additional embodiments, the request includes a request to change strokes with a specific visual attribute in a raster layer to a different visual attribute.

Additionally, in one or more embodiments, the stroke modification system 102 determines one or more strokes associated with the request. In some embodiments, the stroke modification system 102 determines a single stroke within a raster layer. For instance, the stroke modification system 102 determines a coordinate point for the request based on a coordinate system associated with a user input corresponding to the request. The stroke modification system 102 then determines a stroke associated with the request based on a distance of the stroke from the coordinate point of the request. In some embodiments, the stroke modification system 102 determines a subset of strokes within a raster layer in connection with a specific drawing attribute. In further embodiments, the stroke modification system 102 identifies all of the strokes within a raster layer or the entire digital raster image according to the request.

FIG. 2 also illustrates that the series of acts 200 includes an act 208 of updating the drawing data in the metadata file. For instance, in response to a request to modify a drawing attribute of a stroke within a raster layer of a digital raster image, the stroke modification system 102 obtains the drawing data associated with the stroke. To illustrate, the stroke modification system 102 accesses the drawing data for a plurality of drawing points within the metadata file associated with the digital raster image. Specifically, in some embodiments, the drawing data is stored for a plurality of drawing points for each stroke in a map for the corresponding raster layer within the metadata file. The stroke modification system 102 thus determines the drawing data by identifying the drawing points for each of the selected strokes in the correct map for a selected raster layer and extracting the drawing data for the identified drawing points.

Once the stroke modification system 102 has accessed the drawing data for one or more strokes, the stroke modification system 102 updates the drawing data based on the request to modify the one or more strokes. In particular, the stroke modification system 102 updates the drawing data associated with a stroke by changing a stored drawing attribute for a drawing point of the stroke to a new drawing attribute. The stroke modification system 102 thus updates the drawing data for a plurality of drawing points of the stroke to include the new drawing attribute. In some embodiments, the stroke modification system 102 updates drawing data for drawing points from a plurality of strokes in a raster layer, or the entire digital raster image, to the new drawing attribute. In one or more embodiments, the stroke modification system 102 stores the updated drawing data in the metadata file.

FIG. 2 further illustrates that the series of acts 200 includes an act 210 of re-generating the raster layer utilizing the updated drawing data. In one or more embodiments, the stroke modification system 102 modifies the digital raster image by re-generating the raster layer with the updated drawing data that includes the modified drawing attributes according to the request. For instance, in response to a request to modify a plurality of strokes within a raster layer, the stroke modification system 102 re-generates the raster layer by passing the updated drawing data for the plurality of strokes to a rendering engine (e.g., at a client device). Alternatively, in response to a request to modify a subset of strokes in a raster layer while not modifying at least one other stroke in the raster layer, the stroke modification system 102 re-generates the raster layer by passing the updated drawing data for the subset of strokes and original drawing data for the unmodified stroke to the rendering engine. Accordingly, the rendering engine re-draws the entire raster layer including all strokes and other raster elements (e.g., filled regions) within the raster layer.

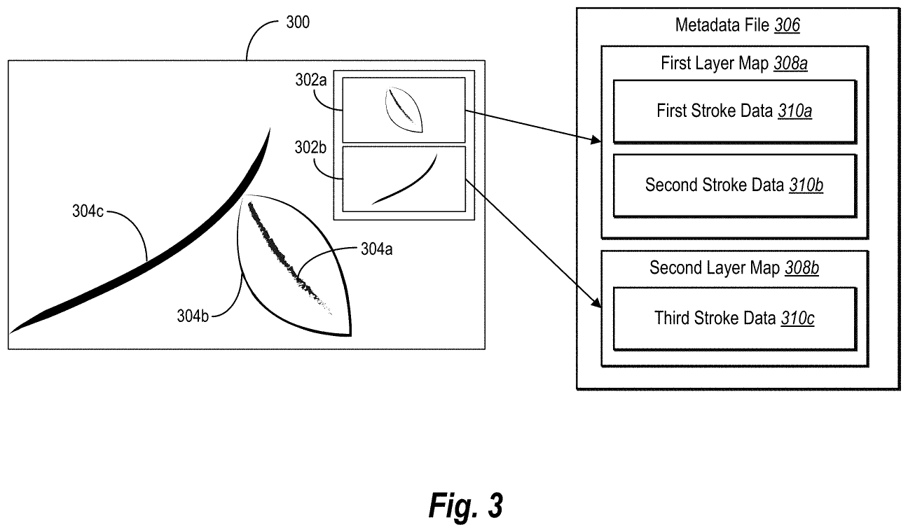

As mentioned, the stroke modification system 102 provides tools for modifying a single stroke within a raster layer or a plurality of strokes within a raster layer. FIG. 3 illustrates an embodiment of a digital raster image 300 including a plurality of raster layers. Furthermore, FIG. 3 illustrates that each raster layer includes one or more strokes. Additionally, FIG. 3 illustrates that the stroke modification system 102 generates drawing data for the raster layers and corresponding strokes to store in metadata associated with the digital raster image 300.

As illustrated in FIG. 3, the digital raster image includes a first raster layer 302a and a second raster layer 302b including a plurality of strokes. Specifically, the first raster layer 302a includes a first stroke 304a and a second stroke 304b. Additionally, the second raster layer 302b includes a third stroke 304c. As shown, the plurality of strokes include a variety of different drawing attributes, resulting in different appearances for the plurality of strokes.

For example, the first stroke 304a includes a first set of visual attributes including a brush type, a stroke size, a color, etc., based on a selected brushstroke tool for a drawing input to draw the first stroke 304a. The first stroke 304a also includes a first set of movement attributes including a velocity, a pressure, angle(s), etc., based on a movement of the drawing input for drawing the first stroke 304a. The second stroke 304b and the third stroke 304c also include corresponding sets of drawing attributes (e.g., corresponding sets of visual attributes and movement attributes) that result in different appearances for each of the strokes.

In one or more embodiments, the stroke modification system 102 determines drawing data for the first stroke 304a, the second stroke 304b, and the third stroke 304c from the corresponding drawing inputs and drawing attributes. For instance, when capturing the drawing data for the first stroke 304a, the stroke modification system 102 captures a plurality of stroke points during a drawing input for the first stroke 304a. To illustrate, the stroke modification system 102 captures a beginning stroke point, an ending stroke point, and a plurality of stroke points between the beginning stroke point and ending stroke point. In some embodiments, the stroke modification system 102 determines the number of stroke points to capture for the stroke based on a predetermined setting indicating a time interval or a distance interval associated with the drawing input.

In connection with each captured stroke point, the stroke modification system 102 determines the drawing attributes of the captured stroke point from the drawing input. For example, the stroke modification system 102 determines drawing attributes for a stroke point along a path of the first stroke 304a by obtaining properties from a brushstroke tool. To illustrate, the stroke modification system 102 determines the visual attributes for the stroke point based on the brush type, a stroke size, a color, etc. of the brushstroke tool. Additionally, the stroke modification system 102 determines the movement attributes (e.g., velocity, pressure, angle(s)) for the stroke point according to the drawing input at the time the stroke modification system 102 captured the stroke point. In one or more embodiments, the stroke modification system 102 captures each stroke point as a data structure and a stroke as a class including a vector of stroke point data structures including a plurality of attributes as point data and stroke data. The point data optionally includes information such as float x, float y, float velocity, float pressure, float rawVelocity, float altitudeAngle, float azimuthAngle, and double time. The stroke data includes vector<PointData> stroke, float strokeTime, and brushInformation.

In the structure above, “x” and “y” represent coordinates within a coordinate system corresponding to a location of the captured point. Additionally, “velocity” and “rawVelocity” represent speed/velocity measurements of the drawing input at the captured point, and “pressure” represents a pressure of the drawing input at the captured point. Furthermore, “altitudeAngle” and “azimuthAngle” represent drawing angles (e.g., an altitude angle and an azimuth angle) of the drawing input at the captured point based on an angle of an input device. The stroke modification system 102 also stores a time at which the stroke modification system 102 captured each stroke point.

In one or more additional embodiments, the stroke modification system 102 determines a vector including captured data for a plurality of stroke points corresponding to a stroke. Accordingly, each stroke corresponds to a different vector including the corresponding stroke points and captured data for the corresponding stroke points. In some embodiments, as shown above, the stroke modification system 102 stores a total time (“strokeTime”) to draw the stroke based on the drawing input. In one or more embodiments, the stroke modification system 102 also stores one or more visual attributes associated with a brushstroke tool (e.g., “brushInformation”) with the vector including the stroke points to associate the visual attributes with each stroke point for the stroke.

After determining drawing data for a stroke point in the first stroke 304a, the stroke modification system 102 stores the drawing data in a metadata file 306. In one or more embodiments, as illustrated in FIG. 3, the stroke modification system 102 generates a layer map for each raster layer in the digital raster image 300. Accordingly, because the digital raster image 300 includes two raster layers (i.e., the first raster layer 302a and the second raster layer 302b), the stroke modification system 102 generates two separate layer maps. More specifically, the stroke modification system 102 generates a first layer map 308a corresponding to the first raster layer 302a and a second layer map 308b corresponding to the second raster layer 302b.

In one or more additional embodiments, the stroke modification system 102 generates entries within each layer map corresponding to strokes within the digital raster image 300. For instance, FIG. 3 illustrates that the stroke modification system 102 generates a first entry in the first layer map 308a corresponding to the first stroke 304a to store first stroke data 310a. in particular, the first stroke data 310a includes the drawing data that the stroke modification system 102 determines for a plurality of stroke points of the first stroke 304a. As mentioned, in one or more embodiments, the stroke modification system 102 generates a vector including the plurality of stroke points for the first stroke 304a. The stroke modification system 102 thus stores the drawing data with the vector comprising the plurality of stroke points as the first stroke data 310a within the first layer map 308a.

Similarly, the stroke modification system 102 generates second stroke data 310b including drawing data for the second stroke 304b. To illustrate, the stroke modification system 102 first determines the drawing data for the second stroke 304b based on a drawing input to draw the second stroke 304b. Specifically, the stroke modification system 102 captures a plurality of stroke points for the second stroke 304b, movement attributes corresponding to the plurality of stroke points of the second stroke 304b, and visual attributes for the second stroke 304b. In one or more embodiments, the stroke modification system 102 then generates the second stroke data 310b to include a vector comprising the stroke points and drawing data for the second stroke 304b. Additionally, the stroke modification system 102 stores the second stroke data 310b in the first layer map 308a with the first stroke data 310a, which indicates that the first stroke 304a and the second stroke 304b are separate raster elements in the same raster layer while optimizing (e.g., reducing) the amount of data required to store the drawing data for a single raster layer.

As previously described, FIG. 3 also illustrates that the stroke modification system 102 stores data from different raster layers in different layer maps. In particular, the stroke modification system 102 generates the second layer map 308b to include drawing data for strokes within the second raster layer 302b. For example, the stroke modification system 102 generates third stroke data 310c to include a vector comprising stroke points and drawing data for the third stroke 304c and stores the third stroke data 310c in the second layer map 308b. Accordingly, the third stroke data 310c is stored separately from the first stroke data 310a and the second stroke 310b to indicate that the third stroke data 310c corresponds to a separate raster layer in the digital raster image 300.

In one or more embodiments, by storing the drawing data for strokes in the metadata file 306 associated with the digital raster image 300, the stroke modification system 102 maintains the drawing data in an easily accessible location. To modify the digital raster image 300, the stroke modification system 102 updates drawing data for one or more strokes within the metadata file 306. For example, in response to a request to modify a drawing attribute of the first stroke 304a, the stroke modification system 102 accesses the first stroke data 310a corresponding to the first stroke 304a from the first layer map 308a of the metadata file 306. In one or more embodiments, the stroke modification system 102 determines that the first stroke 304a is located within the first raster layer 302a and identifies the first layer map 308a (e.g., via a layer identifier). Additionally, the first stroke data 310a includes a stroke identifier mapping the first stroke data 310a to the first stroke 304a.

According to one or more embodiments, the stroke modification system 102 updates the drawing data for the first stroke 304a based on the request. For instance, the stroke modification system 102 determines one or more drawing attributes from the first stroke data 310a in the metadata file 306 to change to a new drawing attribute based on the request. To illustrate, the stroke modification system 102 modifies a visual attribute stored in the first stroke data 310a, such as by changing brushstroke information stored to updated brushstroke information corresponding to a selected brushstroke according to the request. Furthermore, in one or more embodiments, if the request includes a request to change a drawing attribute of the first stroke 304a only, the stroke modification system 102 updates only the first stroke data 310a. Alternatively, if the request includes a request to change a drawing attribute of the first stroke 304a and the second stroke 304b from the first raster layer 302a, the stroke modification system 102 updates the first stroke data 310a and the second stroke data 310b.

After updating the drawing data in the metadata file 306, the stroke modification system 102 modifies the digital raster image 300 utilizing the updated drawing data. For example, the stroke modification system 102 re-generates the first raster layer 302a in the digital raster image 300 by utilizing updated drawing data for any modified strokes. Specifically, in response to update the first stroke data 310a for the first stroke 304a without modifying the second stroke data 310b, the stroke modification system 102 provides the updated first stroke data 310a along with the (unmodified) second stroke data 310b to a rendering engine, which then re-generates the first raster layer 302a utilizing the provided data. Alternatively, in response to modifying the first stroke data 310a and the second stroke data 310b, the stroke modification system 102 provides the updated first stroke data 310a and the updated second stroke data 310b to the rendering engine to re-generate the first raster layer 302a.

In one or more embodiments, the stroke modification system 102 provides a plurality of possible modification operations. For example, the stroke modification system 102 provides an option to re-generate an entire raster layer with a new drawing attribute. In another example, the stroke modification system 102 provides an option to replace a specific drawing attribute of one or more strokes with another drawing attribute within a raster layer. In a further example, the stroke modification system 102 provides an option to replace a drawing attribute for a specific stroke with another drawing attribute. Accordingly, the stroke modification system 102 provides a variety of options for flexibly editing strokes across a number of raster layers.

In one or more embodiments, the stroke modification system 102 performs an operation to re-generate an entire raster layer of a digital raster image with a selected drawing attribute by first clearing the raster layer. The stroke modification system 102 then sets the selected drawing attribute (e.g., a new stroke style) as the drawing attribute for each stroke and/or raster element within the drawing data of the corresponding layer map in the metadata file. Additionally, the stroke modification system 102 utilizes the updated drawing data from the metadata file to re-generate the raster layer with the selected drawing attribute to a rendering engine.

In one or more additional embodiments, the stroke modification system 102 performs an operation to replace a specific drawing attribute with another drawing attribute by determining one or more strokes in a raster layer that include the specific drawing attribute. In at least some instances, the stroke modification system 102 determines a new drawing attribute in response to a selection from a plurality of options. In alternative embodiments, the stroke modification system 102 determines a new drawing attribute in response to a selection of a drawing attribute from an existing stroke (e.g., by utilizing an “eyedropper” tool) and accessing the drawing data from the existing stroke.

Additionally, the stroke modification system 102 receives a selection of the specific drawing attribute to replace with the new drawing attribute. According to one or more embodiments, the stroke modification system 102 obtains a specific drawing attribute by first receiving an input of a selected point within a raster layer of a digital raster image. The stroke modification system 102 then identifies a stroke corresponding to the selected point by performing a nearest point search on the stored stroke points from a layer map in a metadata file and selecting the stroke based on the nearest stored stroke point to the selected point (e.g., using (x,y) coordinates). The stroke modification system 102 determines the specific drawing attribute to replace by obtaining the corresponding drawing attribute (e.g., stroke style) from the drawing data for the selected stroke. Alternatively, the stroke modification system 102 determines the specific drawing attribute in response to a manually selected drawing attribute from a plurality of options.

In one or more embodiments, the stroke modification system 102 identifies any additional strokes that have the specific drawing attribute in the raster layer by accessing the drawing data for one or more strokes from the layer map (if applicable). The stroke modification system 102 updates the corresponding drawing data by replacing the specific drawing attribute with the new drawing attribute for each stroke that has the specific drawing attribute. The stroke modification system 102 then clears the raster layer and re-generates the raster layer utilizing the updated drawing data for strokes for which the stroke modification system 102 replaced the specific drawing attribute with the new drawing attribute.

In one or more embodiments, the stroke modification system 102 also integrates the metadata file 306 with other raster editing operations. For instance, the stroke modification system 102 ties undo or redo operations in the digital raster image to the metadata file 306. More specifically, in response to detecting an undo operation in relation to modifying a drawing attribute of a stroke, the stroke modification system 102 replaces the drawing attribute of the stroke in the metadata file 306 with the previous drawing attribute (e.g., stored in memory). Additionally, in response to detecting a redo operation in relation to modifying a drawing attribute of a stroke, the stroke modification system 102 re-writes the most recent drawing attribute change (e.g., stored in memory) to the metadata file 306. Thus, the stroke modification system 102 maintains parity between the metadata file 306 and undo/redo stacks in a digital editing application.

In one or more additional embodiments, the stroke modification system 102 performs an operation to replace a drawing attribute of a specific stroke with another drawing attribute by first receiving a selection of the stroke in a raster layer of a digital raster image. For example, the stroke modification system 102 receives a selected point in a raster layer of the digital raster image. The stroke modification system 102 determines a corresponding stroke by comparing the coordinates of the selected point to stored stroke points for strokes in the raster layer and then determining a stroke that includes a stroke point closest to the selected point.

After determining a stroke for modifying a drawing attribute, the stroke modification system 102 replaces the drawing attribute for the stroke within a metadata file with a new drawing attribute. For instance, the stroke modification system 102 replaces a stroke style with a new stroke style in the drawing data associated with the stroke within the metadata file. The stroke modification system 102 then clears the raster layer and re-generates the raster layer utilizing the updated drawing data for the stroke including the new drawing attribute. Accordingly, the stroke modification system 102 modifies only the selected stroke within the raster layer without modifying any other strokes within the raster layer.

In additional embodiments, the stroke modification system 102 changes a drawing attribute of the group of selected strokes to a new drawing attribute. For example, the stroke modification system 102 selects the strokes in response to an input via a selection tool that selects at least a portion of each stroke in the group of strokes. Alternatively, the stroke modification system 102 selects the strokes in response to consecutive selection of a plurality of strokes to add the strokes to the group. The stroke modification system 102 then updates the drawing data of the strokes accordingly and re-generates the raster layer with the updated drawing data.

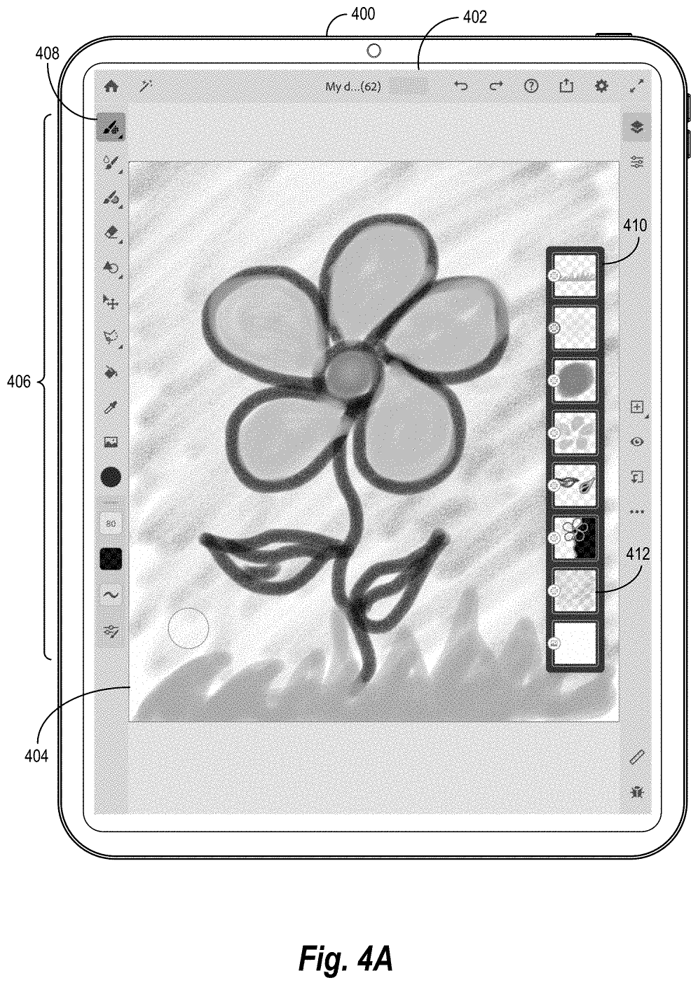

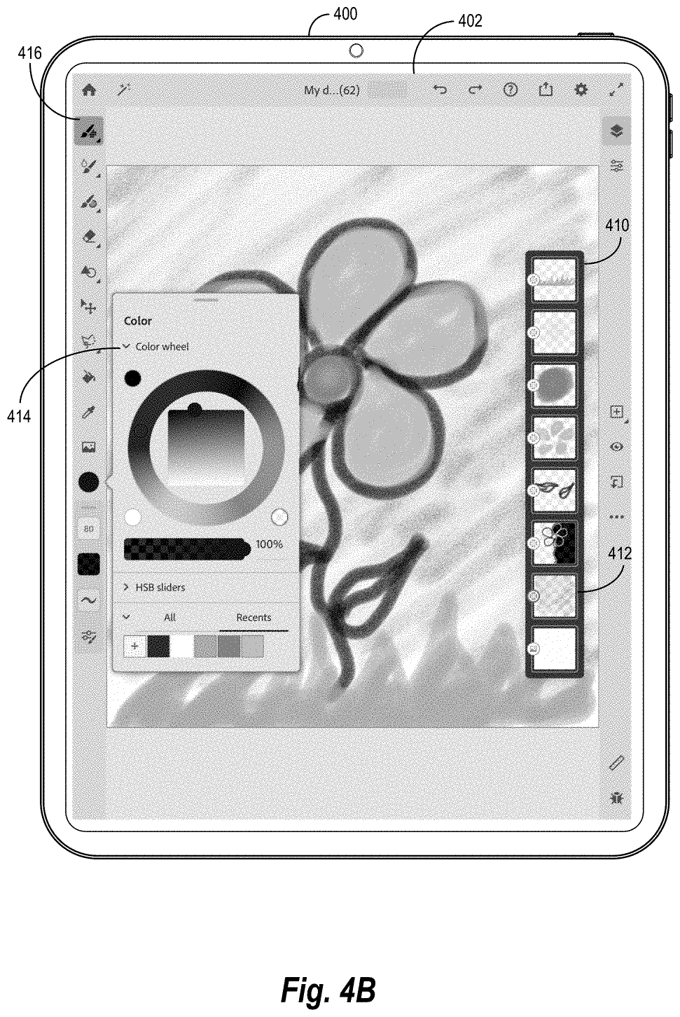

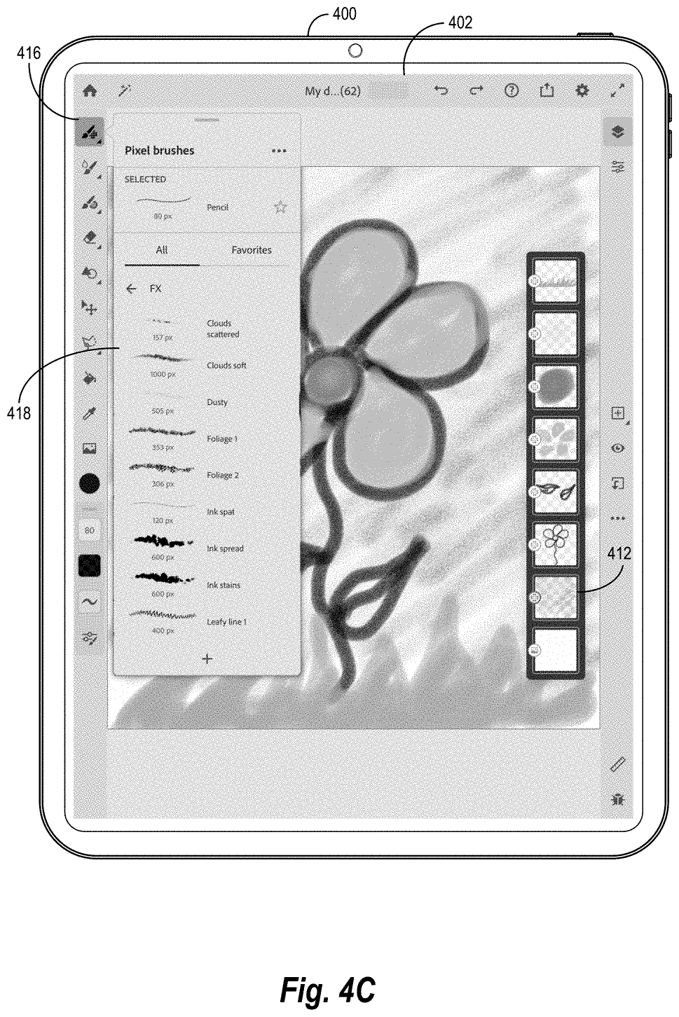

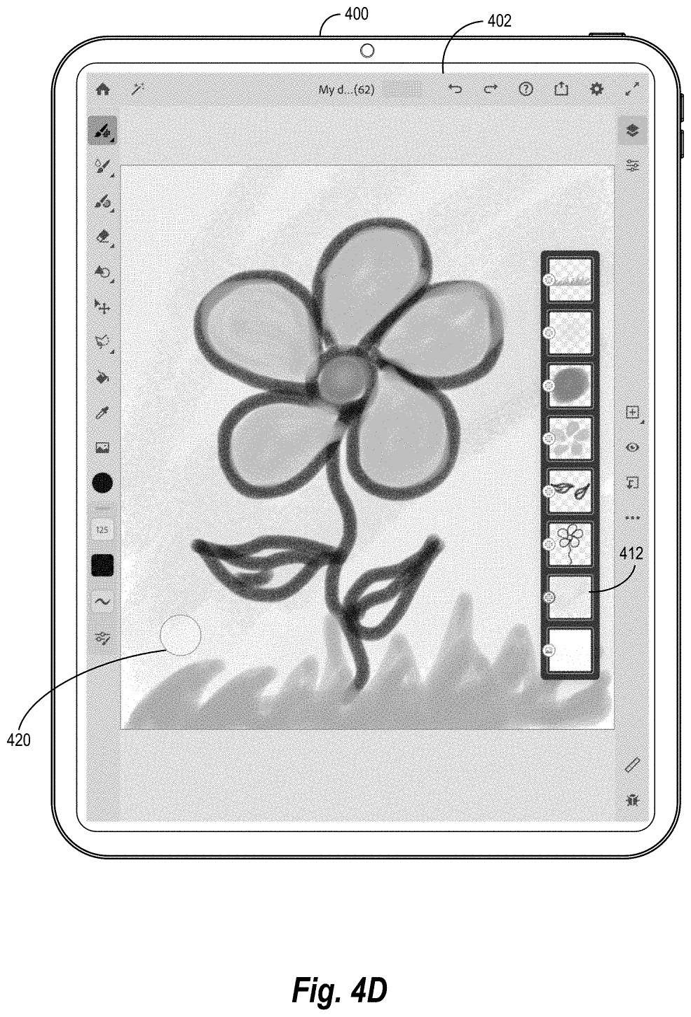

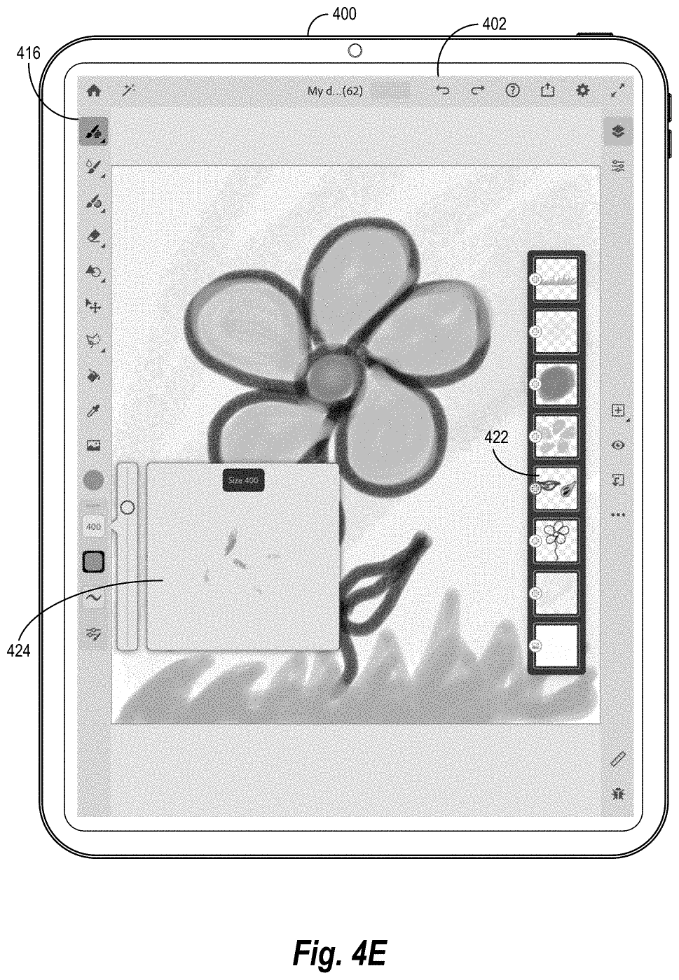

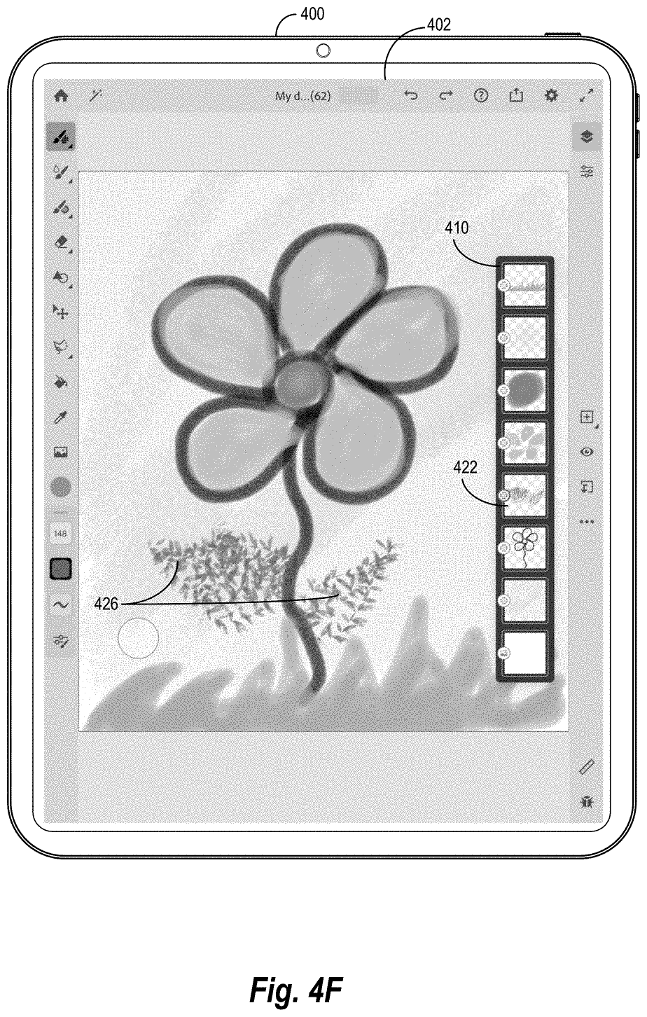

FIGS. 4A-4F illustrate a client device 400 displaying graphical user interfaces in a digital editing application 402 for displaying a digital raster image 404 on a display of the client device 400. In one or more embodiments, the stroke modification system 102 provides the graphical user interfaces via the digital editing application 402 for viewing, editing, or otherwise interacting with the digital raster image 404 on the client device 400. As illustrated, the client device 400 displays the digital raster image 404 including a plurality of strokes or other raster elements (e.g., a filled region).

As illustrated in FIG. 4A, the client device 400 displays a plurality of tools for interacting with the digital raster image 404. For example, the client device 400 displays a toolbar 406 including a variety of brushstroke tools, transformation tools, and tool properties. Selecting a particular tool from the toolbar 406 causes the client device 400 to update the tool properties to display properties associated with the selected tool. For example, selecting a paintbrush tool 408 causes the client device 400 to display paintbrush properties for modifying an output (e.g., an appearance) of the paintbrush tool 408 in a drawing area of the graphical user interface.

In one or more embodiments, the client device 400 also displays a layer pane 410 that includes a plurality of raster layers of the digital raster image 404. For example, digital images include any number of image layers. Accordingly, as shown in FIG. 4A, the digital raster image 404 includes a plurality of raster layers that include various raster elements. To illustrate, the raster layers include one or more strokes or other raster elements (e.g., filled regions) generated utilizing various tools from the toolbar 406.

Specifically, FIG. 4A illustrates that the digital raster image 404 includes a first raster layer 412 that includes a filled region. As shown, the filled region of the first raster layer 412 corresponds to a specific area of the digital raster image 404. Additionally, the filled region in the first raster layer 412 includes drawing data that determines visual attributes of the filled region. For example, the filled region includes a fill type, a fill color, etc., as well as boundaries of the filled region (e.g., borders of the image).

In addition, the first raster layer 412 includes layer properties that determine various visual attributes applicable to all raster elements within the first raster layer 412. For instance, the first raster layer 412 includes a layer stack property indicating a position of the first raster layer 412 relative to other raster layers in the digital raster image 404. To illustrate, the first raster layer 412 is positioned in front of a background layer and behind one or more other layers, such that a rendering engine renders contents of the first raster layer 412 according to the ordering of the raster layers.

In one or more embodiments, the stroke modification system 102 provides tools for modifying drawing attributes of raster elements in the digital raster image 404. For example, FIG. 4B illustrates that the stroke modification system 102 provides modification of a color attribute of the filled region in the first raster layer 412. Specifically, the client device 400 displays a color palette 414 associated with a paintbrush tool 416 in response to a selection of an option to display the color palette 414 (e.g., a color wheel, color sliders). The stroke modification system 102 determines a color in response to an input selecting the color in the color palette 414.

In addition to determining a color attribute to modify for the filled region in the first raster layer 412, the FIG. 4C illustrates that the stroke modification system 102 provides modification of a stroke type associated with the paintbrush tool 416. For instance, the client device 400 displays a brush palette 418 in response to a selection of an option to display the brush palette 418. The stroke modification system 102 determines a stroke type for the paintbrush tool 416 in response to an input selecting the stroke type in the brush palette 418.

After determining one or more visual attributes (e.g., color and a stroke type) for modifying the digital raster image 404, the stroke modification system 102 modifies the digital raster image 404 in response to a user input. FIG. 4D illustrates that the stroke modification system 102 modifies the color and stroke type of the filled region in the first raster layer 412 in response to an input requesting to change the first drawing attributes (e.g., an original color and stroke type) to second drawing attributes (e.g., the selected color and stroke type). For example, the client device 400 first detects that the first raster layer 412 is selected/active in the raster layer stack. Furthermore, the client device 400 detects a touch input 420 (e.g., a double-tap on the filled region via a touch interface of the client device 400) indicating the request to change the drawing attributes. The stroke modification system 102 then modifies the drawing data for the fill region of the first raster layer 412 and re-generates the first raster layer 412 with the new color and stroke style in the fill region.

In one or more additional embodiments, the stroke modification system 102 provides modification of other drawing attributes with raster elements in the digital raster image 404. FIGS. 4E-4F illustrate that the stroke modification system 102 modifies one or more drawing attributes of a plurality of strokes in a second raster layer 422. In particular, FIG. 4E illustrates that the stroke modification system 102 determines a stroke size associated with an input to modify the strokes in the second raster layer 422. FIG. 4F illustrates the strokes in the second raster layer 422 with a plurality of modified drawing attributes.

As illustrated in FIG. 4E, the stroke modification system 102 determines a stroke size for modifying the strokes in the second raster layer 422 in response to a selection of an option to modify the stroke size. For example, the client device 400 displays a stroke size interface 424 for modifying a stroke size of a currently selected tool. To illustrate, modifying the stroke size within the stroke size interface 424 by moving a slider value or otherwise modifying a stroke size value changes a drawing size associated with the currently selected tool (e.g., the paintbrush tool 416). Furthermore, as illustrated, the stroke size interface 424 indicates a selected stroke style for the currently selected tool, which the client device 400 updates in response to a change in stroke style for the currently selected tool.

FIG. 4F illustrates that the stroke modification system 102 modifies one or more drawing attributes of strokes 426 in the second raster layer 422 in response to a request to change the drawing attributes of the strokes 426. Specifically, the client device 400 receives an input activating the second raster layer 422 in the raster layer stack for the digital raster image 404. The stroke modification system 102 also receives an input associated with a request to change one or more drawing attributes of the strokes 426 in the second raster layer 422. For instance, the client device 400 detects an input (e.g., a double-tap) within the second raster layer 422, on a preview icon of the second raster layer 422 in the layer pane 410, or on one or more of the strokes 426 within the second raster layer 422.

In response to detecting the input within the second raster layer 422, the stroke modification system 102 modifies the digital raster layer by updating drawing data for the second raster layer 422. In particular, the stroke modification system 102 accesses metadata for the second raster layer 422 and updates the drawing data for the strokes 426 within the second raster layer 422. For example, the stroke modification system 102 replaces stored brushstroke information (e.g, a stroke style and stroke size) in the drawing data for the strokes 426 with the selected brushstroke information (e.g., the selected stroke style and stroke size). The stroke modification system 102 then re-generates the second raster layer 422 for display on the client device 400 by providing the updated drawing data for the second raster layer 422 to a rendering engine. As illustrated in FIG. 4F, the stroke modification system 102 thus modifies the appearance of the strokes 426 in the second raster layer 422 according to the selected drawing attributes.

In one or more additional embodiments, the stroke modification system 102 provides an option to modify a portion of a stroke within a layer. For example, the stroke modification system 102 receives a selection of a portion of a stroke (e.g., via a selection tool). The stroke modification system 102 accesses metadata for the stroke and determines stroke points corresponding to the selected portion of the stroke. The stroke modification system 102 then updates the drawing data for the stroke by segmenting the drawing data into a first set of drawing data for the selected portion and a second set of drawing data for an unselected portion. To illustrate, the stroke modification system 102 divides the stroke into two different strokes within the metadata file. The stroke modification system 102 modifies the first set of drawing data for the selected portion and then re-generates the raster layer utilizing the updated data.

In some embodiments, the stroke modification system 102 provides an option to delete some or all of a stroke within a digital raster image. Specifically, the stroke modification system 102 detects a selection of a stroke within a raster layer of the digital image. In response to detecting a selection of an option to delete the stroke, the stroke modification system 102 obtains the drawing data for the stroke from a metadata file associated with the digital raster image. The stroke modification system 102 then deletes the drawing data (including the stroke points) associated with the stroke from the metadata file and then re-generates the raster layer utilizing the updated drawing data/metadata file to remove the stroke from the raster layer.

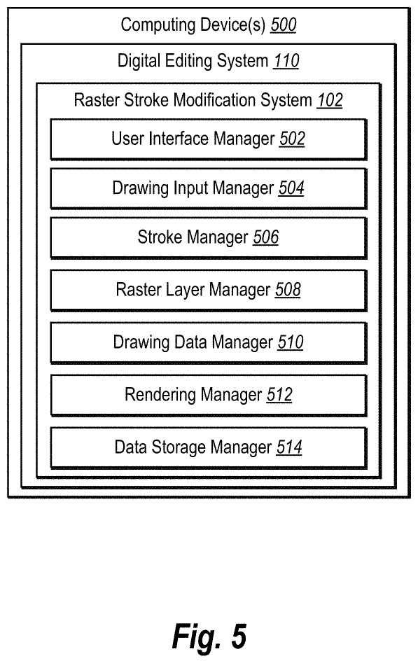

FIG. 5 illustrates a detailed schematic diagram of an embodiment of the stroke modification system 102 described above. As shown, the stroke modification system 102 is implemented in the digital editing system 110 on computing device(s) 500 (e.g., a client device and/or server device as described in FIG. 1, and as further described below in relation to FIG. 7). Additionally, in one or more embodiments, the stroke modification system 102 includes, but is not limited to, a user interface manager 502, a drawing input manager 504, a stroke manager 506, a raster layer manager 508, a drawing data manager 510, a rendering manager 512, and a data storage manager 514. The stroke modification system 102 can be implemented on any number of computing devices. For example, in some embodiments, the stroke modification system 102 is implemented in a distributed system of server devices for managing digital images and other digital content items. In additional embodiments, the stroke modification system 102 is implemented within one or more additional systems. In alternative embodiments, the stroke modification system 102 is implemented on a single computing device such as a single client device.

In one or more embodiments, each of the components of the stroke modification system 102 is in communication with other components using any suitable communication technologies. Additionally, in some embodiments, the components of the stroke modification system 102 are in communication with one or other devices including other computing devices of a user, server devices (e.g., cloud storage devices), licensing servers, or other devices/systems. It will be recognized that although the components of the stroke modification system 102 are shown to be separate in FIG. 5, in one or more embodiments, one or more of the subcomponents are combined into fewer components, such as into a single component, or divided into more components as may serve a particular implementation. Furthermore, although the components of FIG. 5 are described in connection with the stroke modification system 102, in alternative embodiments, at least some of the components for performing operations in conjunction with the stroke modification system 102 described herein are implemented on other devices within the environment.

The components of the stroke modification system 102 can include software, hardware, or both. For example, in one or more embodiments, the components of the stroke modification system 102 include one or more instructions stored on a computer-readable storage medium and executable by processors of one or more computing devices (e.g., the computing device(s) 500). When executed by the one or more processors, the computer-executable instructions of the stroke modification system 102 cause the computing device(s) 500 to perform the operations described herein. Alternatively, the components of the stroke modification system 102 include hardware, such as a special purpose processing device to perform a certain function or group of functions. Additionally, or alternatively, the components of the stroke modification system 102 include a combination of computer-executable instructions and hardware.

Furthermore, the components of the stroke modification system 102 performing the functions described herein with respect to the stroke modification system 102 may, for example, be implemented as part of a stand-alone application, as a module of an application, as a plug-in for applications, as a library function or functions that may be called by other applications, and/or as a cloud-computing model. Thus, the components of the stroke modification system 102 may be implemented as part of a stand-alone application on a personal computing device or a mobile device. In some embodiments, the components of the stroke modification system 102 are implemented in an application that provides digital image editing, including, but not limited to CREATIVE CLOUD®, PHOTOSHOP®, and ADOBE FRESCO®. The foregoing are either registered trademarks or trademarks of Adobe Inc. in the United States and/or other countries.

As mentioned, the stroke modification system 102 includes a user interface manager 502 to manage the display of content on a display device of a client device. For example, the user interface manager 502 determines how and where content is displayed on the display device. To illustrate, the user interface manager 502 communicates with the display device to present content in one or more raster layers of a digital raster image in connection with one or more applications (e.g., digital editing applications) associated with the stroke modification system 102 and/or the digital editing system 110.

The stroke modification system 102 also includes a drawing input manager 504 to manage drawing inputs associated with drawing tools. For example, the drawing input manager 504 manages inputs from one or more input devices to insert content within a digital raster image. Additionally, the drawing input manager 504 manages a drawing stream associated with a drawing input to draw a stroke or other raster element within a digital raster image. The drawing input manager 504 also communicates with the rendering manager 512 to draw content within a digital raster image based on drawing inputs.

The stroke modification system 102 includes a stroke manager 506 to manage strokes inserted into a digital raster image. For instance, the stroke manager 506 manages individual strokes by capturing stroke points from drawing inputs within a digital raster image. To illustrate, the stroke manager 506 determines an appearance and location of each stroke according to brushstroke information and data associated with drawing inputs to draw the strokes.

The stroke modification system 102 further includes a raster layer manager 508 to manage one or more raster layers within a digital raster image. Specifically, the raster layer manager 508 manages raster layer properties associated with each raster layer in a digital raster image indicating an effect of each raster layer on a display device for the digital raster image. Additionally, the raster layer manager 508 manages a raster layer stack to determine a position of each raster layer within the raster layer stack and how each raster layer affects other raster layers within the digital raster image.

Additionally, the stroke modification system 102 includes a drawing data manager 510 to manage drawing data for raster elements in a digital raster image. For example, the drawing data manager 510 manages visual attributes and movement attributes associated with strokes draw in a digital raster image. The drawing data manager 510 also manages a metadata file including drawing data for stroke points of strokes in a digital raster image. To illustrate, the drawing data manager 510 generates a metadata file including layer maps and layer map entries for raster layers and strokes (or raster elements) in a digital raster image, respectively.

The stroke modification system 102 also includes a rendering manager 512 to render a digital raster image on a display device. In particular, the rendering manager 512 utilizes a rendering engine (e.g., of a client device that includes the display device) to render content of one or more raster layers in a digital raster image on the display device. The rendering manager 512 also communicates with the drawing data manager 510 to obtain drawing data and/or updated drawing data to render a digital raster image including any modifications to strokes within one or more raster layers of the digital raster image.

The stroke modification system 102 includes a data storage manager 514 (that comprises a non-transitory computer memory/one or more memory devices) to manage data that the other components in the stroke modification system 102 use and/or produce. Specifically, the data storage manager 514 stores and maintains data associated with generating and modifying digital raster images. For instance, the data storage manager 514 stores information associated with generating strokes or other raster elements within a digital raster image such as a metadata file including stroke points and drawing attributes of the strokes and/or raster elements.

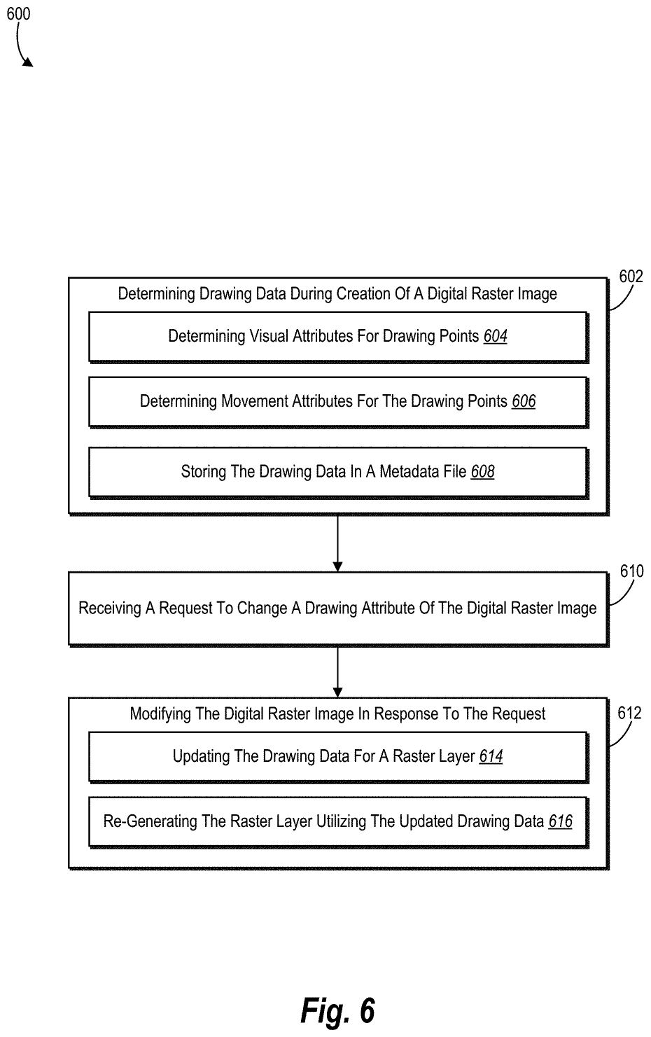

Turning now to FIG. 6, this figure shows a flowchart of a series of acts 600 of modifying drawing characteristics of digital raster images utilizing stroke properties. While FIG. 6 illustrates acts according to one embodiment, alternative embodiments may omit, add to, reorder, and/or modify any of the acts shown in FIG. 6. The acts of FIG. 6 are optionally performed as part of a method. Alternatively, a non-transitory computer readable medium comprises instructions, that when executed by one or more processors, cause a computing device to perform the acts of FIG. 6. In still further embodiments, a system performs the acts of FIG. 6.

As shown, the series of acts 600 includes an act 602 of determining drawing data during creation of a digital raster image. For example, act 602 involves determining drawing data for a plurality of drawing points from drawing input during creation of a digital raster image. Act 602 involves determining the drawing data for a plurality of drawing points from drawing input for a raster layer of a digital raster image by capturing the plurality of drawing points utilizing a coordinate system of a computing device receiving the drawing input.

Act 602 involves determining that the drawing input generates a first stroke comprising a first subset of the plurality of drawing points in a raster layer. Additionally, act 602 involves determining that the drawing input generates a second stroke comprising a second subset of the plurality of drawing points in the raster layer. For example, act 602 involves receiving a stroke input to draw a stroke within the raster layer of the digital raster image. Act 602 also optionally involves receiving an additional stroke input to draw an additional stroke within the raster layer of the digital raster image.

As part of act 602, for example, the series of acts 600 includes an act 604 of determining visual attributes for drawing points. For example, act 604 involves determining visual attributes of the drawing input. Act 604 involves determining visual attributes comprising a stroke style and a stroke size of the drawing input. In one or more embodiments, act 604 involves determining drawing data for a plurality of stroke points of the first stroke captured from the stroke input utilizing a coordinate system associated with the stroke input.

Also as part of act 602, the series of acts 600 includes an act 606 of determining movement attributes for the drawing points. For example, act 606 involves determining movement attributes associated with the drawing input. Act 606 involves determining movement attributes comprising a velocity, a pressure, drawing angles, and a drawing speed associated with the drawing input.

The series of acts 600 further includes an act 608 of storing the drawing data in a metadata file. For example, act 608 involves storing the drawing data for the plurality of drawing points from the drawing input in a metadata file associated with the digital raster image by storing the visual attributes and the movement attributes with the plurality of drawing points with a vector comprising the plurality of drawing points within the metadata file. Act 608 involves generating a layer map for a raster layer comprising a first entry including first drawing data associated with the first stroke and a second entry including second drawing data associated with the second stroke.

Additionally, the series of acts 600 includes an act 610 of receiving a request to change a drawing attribute of the digital raster image. For example, act 610 involves receiving a request to change a first drawing attribute of the digital raster image to a second drawing attribute. Act 610 involves receiving the request to change the first drawing attribute of the digital raster image to the second drawing attribute by receiving a request to change a visual attribute of the first stroke to a selected visual attribute. To illustrate, act 610 involves receiving a request to change a first stroke style of a stroke to a second stroke style.

Act 610 involves receiving a selection to replace the first drawing attribute with the second drawing attribute in a plurality of strokes comprising the first drawing attribute within the raster layer. Act 610 involves receiving a selection to replace the first drawing attribute with the second drawing attribute in a first stroke of a plurality of strokes within the raster layer. Act 610 involves receiving a selection to replace one or more drawing attributes of one or more strokes in the raster layer with a selected drawing attribute.

In one or more embodiments, act 610 involves receiving a request to change a visual attribute of the first stroke to a selected visual attribute. Alternatively, act 610 involves receiving a request to change visual attributes of the first stroke and the second stroke to a selected visual attribute. Act 610 alternatively involves receiving a request to delete at least one portion of a selected stroke from the digital raster image.

Act 610 involves determining a coordinate point in response to a user input within a coordinate system associated with the drawing input. Act 610 then involves selecting the first stroke in response to determining that the coordinate point is nearest a drawing point in the first subset of the plurality of drawing points in the raster layer. In one or more embodiments, act 610 also involves determining that the first stroke comprises the first drawing attribute.

Furthermore, the series of acts 600 includes an act 612 of modifying the digital raster image in response to the request. For example, act 612 involves modifying the digital raster image by utilizing the drawing data to generate a revised digital raster image that includes the second drawing attribute in place of the first drawing attribute in response to the request to change the first drawing attribute associated with the drawing input.

As part of act 612, the series of acts 600 includes an act 614 of updating the drawing data for a raster layer. For example, act 614 involves updating the drawing data for a raster layer by changing drawing attributes in drawing data for one or more strokes associated with the raster layer. To illustrate, act 614 involves accessing one or more entries in a layer map associated with the raster layer and modifying drawing data stored in the one or more entries in the layer map.

For example, act 614 involves replacing the first drawing attribute with the second drawing attribute in drawing data for the plurality of strokes within the raster layer. Act 614 involves replacing the first drawing attribute with the second drawing attribute in drawing data for the first stroke within the raster layer without modifying drawing data for a second stroke of the plurality of strokes within the raster layer. Act 614 alternatively involves replacing the one or more drawing attributes of the one or more strokes with the selected drawing attribute in drawing data for the one or more strokes within the raster layer.

Also as part of 612, the series of acts 600 includes an act 616 of re-generating the raster layer utilizing the updated drawing data. For example, act 616 involves re-generating the raster layer utilizing the updated drawing data including the second drawing attribute in place of the first drawing attribute for the plurality of drawing points.

Act 616 involves utilizing the drawing data to generate the revised digital raster image by re-generating the raster layer to include the first stroke with the selected visual attribute. Act 616 involves utilizing the drawing data to generate the revised digital raster image by re-generating the raster layer to include the first stroke and the second stroke with the selected visual attribute. Alternatively, Act 616 involves utilizing the drawing data to generate the revised digital raster image by excluding a subset of the plurality of drawing points and drawing data corresponding to the at least one portion of the selected stroke from the revised digital raster image.

In one or more embodiments, act 616 involves clearing the raster layer from the digital raster image. Act 616 then involves updating drawing data corresponding to the first subset of the plurality of drawing points by replacing the visual attribute of the first stroke to the selected visual attribute. Act 616 also involves providing the updated drawing data with the selected visual attribute to a rendering engine.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that one or more computing devices such as the computing device 700 may implement the system(s) of FIG. 1. As shown by FIG. 7, the computing device 700 can comprise a processor 702, a memory 704, a storage device 706, an I/O interface 708, and a communication interface 710, which may be communicatively coupled by way of a communication infrastructure 712. In certain embodiments, the computing device 700 can include fewer or more components than those shown in FIG. 7. Components of the computing device 700 shown in FIG. 7 will now be described in additional detail.

In one or more embodiments, the processor 702 includes hardware for executing instructions, such as those making up a computer program. As an example, and not by way of limitation, to execute instructions for dynamically modifying workflows, the processor 702 may retrieve (or fetch) the instructions from an internal register, an internal cache, the memory 704, or the storage device 706 and decode and execute them. The memory 704 may be a volatile or non-volatile memory used for storing data, metadata, and programs for execution by the processor(s). The storage device 706 includes storage, such as a hard disk, flash disk drive, or other digital storage device, for storing data or instructions for performing the methods described herein.

The I/O interface 708 allows a user to provide input to, receive output from, and otherwise transfer data to and receive data from computing device 700. The I/O interface 708 may include a mouse, a keypad or a keyboard, a touch screen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example, and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 710 may facilitate communications with various types of wired or wireless networks. The communication interface 710 may also facilitate communications using various communication protocols. The communication infrastructure 712 may also include hardware, software, or both that couples components of the computing device 700 to each other. For example, the communication interface 710 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

1. A non-transitory computer readable storage medium comprising instructions that, when executed by at least one processor, cause a computing device to:
determine drawing data for a plurality of drawing points from drawing input during creation of a digital raster image by:
determining first stroke data for a first stroke in a raster layer; and
determining second stroke data for a second stroke in the raster layer;
receive a request to change a first drawing attribute of the first stroke in the digital raster image to a second drawing attribute; and
modify the digital raster image by utilizing the drawing data to generate a revised digital raster image that includes the second drawing attribute in place of the first drawing attribute in response to the request to change the first drawing attribute associated with the drawing input by:
clearing the raster layer from the digital raster image; and
re-generating the raster layer comprising the first stroke data with the second drawing attribute without modifying the second stroke data.

2. The non-transitory computer readable storage medium as recited in claim 1, further comprising instructions that, when executed by the at least one processor, cause the computing device to determine the drawing data for the plurality of drawing points by:
determining visual attributes of the drawing input; and
determining movement attributes associated with the drawing input.

3. The non-transitory computer readable storage medium as recited in claim 2, further comprising instructions that, when executed by the at least one processor, cause the computing device to store the drawing data for the plurality of drawing points from the drawing input in a metadata file associated with the digital raster image by storing the visual attributes and the movement attributes with the plurality of drawing points with a plurality of vectors comprising the plurality of drawing points within the metadata file.

4. The non-transitory computer readable storage medium as recited in claim 1, further comprising instructions that, when executed by the at least one processor, cause the computing device to determine the drawing data for the plurality of drawing points by:
determining that the drawing input generates the first stroke comprising a first subset of the plurality of drawing points in the raster layer with a first set of attributes comprising the first drawing attribute; and
determining that the drawing input generates the second stroke comprising a second subset of the plurality of drawing points in the raster layer with a second set of attributes.

5. The non-transitory computer readable storage medium as recited in claim 4, further comprising instructions that, when executed by the at least one processor, cause the computing device to:
receive the request to change the first drawing attribute of the digital raster image to the second drawing attribute by receiving a request to change a visual attribute of the first stroke to a selected visual attribute; and
modify the digital raster image by utilizing the drawing data to generate the revised digital raster image by re-generating the raster layer to include the first subset of the plurality of drawing points of the first stroke with the selected visual attribute without modifying the second subset of the plurality of drawing points of the second stroke.

6. The non-transitory computer readable storage medium as recited in claim 5, further comprising instructions that, when executed by the at least one processor, cause the computing device to re-generate the raster layer by:
updating the first stroke data corresponding to the first subset of the plurality of drawing points by replacing the visual attribute of the first stroke to the selected visual attribute; and
providing the updated first stroke data with the selected visual attribute and the second stroke data to a rendering engine.

7. The non-transitory computer readable storage medium as recited in claim 5, further comprising instructions that, when executed by the at least one processor, cause the computing device to receive the request to change the first drawing attribute of the digital raster image to the second drawing attribute by:
determining a coordinate point in response to a user input within a coordinate system associated with the drawing input; and
selecting the first stroke in response to determining that the coordinate point is nearest a drawing point in the first subset of the plurality of drawing points in the raster layer.

8. The non-transitory computer readable storage medium as recited in claim 4, further comprising instructions that, when executed by the at least one processor, cause the computing device to:
receive the request to change the first drawing attribute of the digital raster image to the second drawing attribute by receiving a request to change visual attributes of the first stroke and a third stroke in the raster layer to a selected visual attribute; and
modify the digital raster image by utilizing the drawing data to generate the revised digital raster image by re-generating the raster layer to include the first stroke and the third stroke with the selected visual attribute without modifying the second stroke.

9. The non-transitory computer readable storage medium as recited in claim 1, further comprising instructions that, when executed by the at least one processor, cause the computing device to:
receive the request to change the first drawing attribute of the digital raster image to the second drawing attribute by receiving a request to delete at least one portion of the first stroke from the digital raster image; and
modify the digital raster image by utilizing the drawing data to generate the revised digital raster image by excluding a subset of the plurality of drawing points and drawing data corresponding to the at least one portion of the first stroke from the revised digital raster image.

10. A system comprising:
a memory device; and
one or more servers configured to cause the system to:
determine drawing data for a plurality of drawing points from drawing input for a raster layer of a digital raster image by capturing the plurality of drawing points utilizing a coordinate system of a computing device receiving the drawing input by:
determining first stroke data for a first stroke in a raster layer; and
determining second stroke data for a second stroke in the raster layer;
receive a request to change a first drawing attribute of the first stroke in the digital raster image to a second drawing attribute; and
modify the digital raster image to generate a revised digital raster image that includes the second drawing attribute in place of the first drawing attribute by:
clearing the raster layer from the digital raster image;
updating the drawing data for the plurality of drawing points by modifying the first stroke data with the second drawing attribute without modifying the second stroke data in response to the request to change the first drawing attribute to the second drawing attribute; and
re-generating the raster layer utilizing the updated drawing data comprising the second drawing attribute in the first stroke data.

11. The system as recited in claim 10, wherein the one or more servers are further configured to cause the system to determine the drawing data for the plurality of drawing points by:
determining visual attributes comprising a stroke style and a stroke size of the drawing input;
determining movement attributes comprising a velocity, a pressure, drawing angles, and a drawing speed associated with the drawing input; and
storing the visual attributes and the movement attributes associated with the drawing input with a plurality of vectors comprising the plurality of drawing points within a metadata file associated with the digital raster image.

12. The system as recited in claim 10, wherein the one or more servers are further configured to cause the system to:
receive the request to change the first drawing attribute of the digital raster image to the second drawing attribute by receiving a selection to replace the first drawing attribute with the second drawing attribute in each stroke that comprises the first drawing attribute within the raster layer; and
update the drawing data for the plurality of drawing points by replacing the first drawing attribute with the second drawing attribute in the first stroke data and additional stroke data corresponding to a third stroke within the raster layer without modifying the second stroke data.

13. The system as recited in claim 10, wherein the one or more servers are further configured to cause the system to:
receive the request to change the first drawing attribute of the digital raster image to the second drawing attribute by receiving a selection to replace a first brushstroke attribute of the first stroke to a second brushstroke attribute; and
update the drawing data by replacing the first drawing attribute in the first stroke data with the second drawing attribute without modifying the second stroke data for the second stroke.

14. The system as recited in claim 13, wherein the one or more servers are further configured to cause the system to receive the selection to replace the first drawing attribute with the second drawing attribute in the first stroke by:
determining a coordinate point in response to a user input within a coordinate system associated with the drawing input;
selecting the first stroke in response to determining that the coordinate point is nearest a drawing point in a subset of the plurality of drawing points corresponding to the first stroke in the raster layer; and
determining that the first stroke comprises the first brushstroke attribute.

15. The system as recited in claim 10, wherein the one or more servers are further configured to cause the system to:
update the drawing data for the plurality of drawing points by replacing the first drawing attribute of a subset of the plurality of drawing points corresponding to the first stroke with the second drawing attribute in drawing data for the subset of the plurality of drawing points.

16. The system as recited in claim 10, wherein the one or more servers are further configured to cause the system to re-generate the raster layer by:
providing the updated drawing data with the second drawing attribute in the first stroke data to a rendering engine.

17. A method comprising:
receiving, by at least one processor, a plurality of stroke inputs to draw a plurality of strokes within a raster layer of a digital raster image;
determining, by the at least one processor, drawing data for a plurality of stroke points of the plurality of strokes captured from the plurality of stroke inputs utilizing a coordinate system associated with the plurality of stroke inputs by:
determining first stroke data for a first stroke in a raster layer; and
determining second stroke data for a second stroke in the raster layer;
receiving, by the at least one processor, a request to change a first drawing attribute of the first stroke to a second drawing attribute; and
modifying, by the at least one processor, the digital raster image to generate a revised digital raster image that includes the second drawing attribute in place of the first drawing attribute by:
clearing the raster layer from the digital raster image;
updating the drawing data for the plurality of stroke points by modifying the first stroke data with the second drawing attribute without modifying the second stroke data in response to the request to change the first drawing attribute of the first stroke to the second drawing attribute; and
re-generating the raster layer utilizing the updated drawing data comprising the second drawing attribute in the first stroke data.

18. The method as recited in claim 17, further comprising:
receiving an additional stroke input to draw an additional stroke within the raster layer of the digital raster image;
determining additional stroke data for a plurality of additional stroke points of the additional stroke captured from the additional stroke input; and
storing the first stroke data associated with the first stroke and the additional stroke data associated with the additional stroke within a metadata file associated with the digital raster image.

19. The method as recited in claim 18, wherein:
storing the first stroke data associated with the first stroke and the additional stroke data associated with the additional stroke comprises generating a layer map for the raster layer comprising an entry including the first stroke data associated with the first stroke and an additional entry including the additional stroke data associated with the additional stroke; and
updating the drawing data for a subset of the plurality of stroke points by replacing the first drawing attribute with the second drawing attribute in the entry including the first stroke data associated with the first stroke without modifying the additional stroke data associated with the additional stroke.

20. The method as recited in claim 17, wherein receiving the request to change the first drawing attribute of the first stroke to the second drawing attribute comprises receiving a request to change a first stroke style of the first stroke to a second stroke style.
